(19) United States
(12) Patent Application Publication
(10) Pub. No.: US 2023/0275640 A1
(43) Pub. Date: Aug. 31, 2023

(54) DEVICES AND METHODS FOR ANTENNA MANAGEMENT RELATED TO MILLIMETER-WAVE WEARABLE TECHNOLOGY

(71) Applicant: Skyworks Solutions, Inc., Irvine, CA (US)

(72) Inventor: David Richard Pehlke, Westlake Village, CA (US)

(21) Appl. No.: 18/114,159

(22) Filed: Feb. 24, 2023

Related U.S. Application Data
(60) Provisional application No. 63/314,170, filed on Feb. 25, 2022.
(60) Provisional application No. 63/314,251, filed on Feb. 25, 2022.

(51) Int. Cl. H04B 7/06; H04W 76/25; H04B 1/3827

(52) U.S. Cl. CPC H04B 7/0691; H04W 76/25; H04B 1/385

(57) ABSTRACT

Embodiments of the invention relate to a wearable device comprising a body portion including a front-end system, one or more sensors, and a beam management circuit, and an external portion connected to the body portion comprising a first antenna array. The frontend system is operable to condition radio-frequency signals communicated via the first antenna array to thereby form a beam. The beam management circuit is configured to control the frontend system to manage the beam, such as by switching transmission between different subsets of antenna elements of the antenna array, or by switching transmission from the first antenna array to a second antenna array located on the external portion.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

Embodiments of the invention relate to the field of wearable devices and, more particularly, to antenna configurations for wearable devices having mm-wave functionality and methods for maintaining wireless connectivity.

### Description of the Related Technology

Wearable devices often include wireless communication functionality. For example, wearable devices may contain antennae and wireless transceivers for supporting wireless communications. Some wireless communications technologies, such as millimeter-wave communications involve communications at high frequencies. Wireless communications at such high frequencies makes the placement of antennae increasingly important, particularly in compact wearable devices.

### SUMMARY

According to one embodiment there is provided a wearable device, comprising a body portion including a frontend system, one or more sensors, and a beam management circuit, an external portion connected to the body portion, the external portion including a first antenna array having one or more first antenna elements, the frontend system being electrically connected to the first antenna array and operable to condition a plurality of radio frequency signals each communicated by a corresponding first subset of the one or more first antenna elements of the first antenna array to thereby form a beam, the radio-frequency signals having a frequency between 6 GHz and 300 GHz, the one or more sensors being configured to generate sensor data, and the beam management circuit being for managing the beam, the beam management circuit being configured to control the frontend system to manage the beam based on one or more signals received via the first antenna array.

In one example the external portion is a strap for securing the wearable device to a user.

In one example the external portion includes a plurality of antennas arranged along the length of the external portion.

In one example the first antenna includes a plurality of first antenna elements and extends along at least 75% the length of the external portion.

In one example the management of the beam includes adjusting an angle of the beam.

In one example the external portion further comprises a second antenna array including one or more second antenna elements.

In one example the management of the beam includes switching transmission from the first antenna array to the second antenna array.

In one example the first antenna array includes a plurality of first antenna elements, and the management of the beam includes switching transmission to a second subset of the one or more first antenna elements of the first antenna array.

In one example the beam management circuit is configured to adjust the angle of the beam based on the one or more received signals maintain the beam pointed at an external device.

In one example the external device is a base station.

In one example the one or more sensors comprise a Global Positioning System (GPS) sensor.

In one example the GPS sensor comprises an L1 and L5 Global Navigation Satellite System (GNSS) module.

In one example the one or more sensors comprise an accelerometer.

In one example the one or more sensors comprise an ultra-wideband positioning system.

In one example the wearable device is a wristwatch.

In one example the wearable device is a pair of smart glasses, the external portion comprising a pair of side arms.

In one example the wearable device includes a plurality of antennas arranged along the length of one or each of the side arms.

In one example the first antenna includes a plurality of first antenna elements and extends along at least 75% of the length of one the side arms.

In one example the beam is a transmit beam.

In one example the beam is a receive beam.

According to another embodiment there is provided a method of beam management in a wearable device, the wearable device comprising a body portion including a frontend system, one or more sensors, and a beam management circuit; and an external portion connected to the body portion, the external portion including a first antenna array having one or more first antenna elements, the method comprising conditioning, via the frontend system, a plurality of radio-frequency signals using a frontend system, communicating each of the plurality of radio-frequency signals by a corresponding first subset of one or more first antenna elements of a first antenna array to form a beam, the radio-frequency signals having a frequency between 6 GHz and 300 GHz, controlling, via the beam management circuit, the frontend system to manage the beam based on one or more signals received by the first antenna array.

In one example controlling the frontend system includes controlling the frontend system to adjust an angle of the beam.

In one example controlling the frontend system includes controlling the frontend system to switch transmission from the first antenna array to a second antenna array.

In one example controlling the frontend system includes controlling the frontend system to switch transmission to a second subset of the first antenna elements of the first antenna array.

In one example controlling the frontend system includes controlling the frontend system to adjust the angle of the beam based on the one or more received signals to maintain the beam pointed at an external device.

According to another embodiment there is provided a wearable device comprising a body portion including a frontend system, one or more sensors, a beam management circuit, and a body antenna, an external portion connected to the body portion, the external portion including a first antenna array having one or more first antenna elements, the frontend system being electrically connected to the first antenna array and operable to condition a plurality of radio frequency signals each communicated by a corresponding first subset of the one or more first antenna elements of the first antenna array to thereby form a beam, the radio-frequency signals having a frequency between 6 GHz and 300 GHz, the one or more sensors being configured to generate sensor data; and the beam management circuit for managing the beam, the beam management circuit being configured to control the frontend system to manage the beam based on one or more signals received by the first antenna array.

In one example the body antenna is configured to communicate radio-frequency signals, the radio-frequency signals having a frequency below 6 GHz.

According to another embodiment there is provided a wearable device, comprising a body portion including a frontend system, one or more sensors, and a beam management circuit, an external portion connected to the body portion, the external portion including a first antenna array having one or more first antenna elements; the frontend system being electrically connected to the first antenna array and operable to condition a plurality of radio frequency signals each communicated by a corresponding first subset of the one or more first antenna elements of the first antenna array to thereby form a beam, the radio-frequency signals having a frequency between 6 GHz and 300 GHz, the one or more sensors being configured to generate sensor data; and the beam management circuit for managing the beam, the beam management circuit being configured to control the frontend system to manage the beam based on sensor data generated by the one or more sensors.

In one example the external portion is a strap for securing the wearable device to a user.

In one example the external portion includes a plurality of antennas arranged along the length of the external portion.

In one example the first antenna includes a plurality of first antenna elements and extends along at least 75% the length of the external portion.

In one example the management of the beam includes adjusting an angle of the beam.

In one example the external portion further comprises a second antenna array including one or more second antenna elements.

In one example the management of the beam includes switching transmission from the first antenna array to the second antenna array.

In one example the first antenna array includes a plurality of first antenna elements, and the management of the beam includes switching transmission to a second subset of the one or more first antenna elements of the first antenna array.

In one example the beam management circuit is configured to adjust the angle of the beam based on the generated sensor data to maintain the beam pointed at an external device.

In one example the external device is a base station.

In one example the one or more sensors comprise a Global Positioning System (GPS) sensor.

In one example the GPS sensor comprises an L1 and L5 Global Navigation Satellite System (GNSS) module.

In one example the one or more sensors comprise an accelerometer.

In one example the one or more sensors comprise an ultra-wideband positioning system.

In one example the wearable device is a wristwatch.

In one example the wearable device is a pair of smart glasses, the external portion comprising a pair of side arms.

In one example the wearable device includes a plurality of antennas arranged along the length of one or each of the side arms.

In one example the first antenna includes a plurality of first antenna elements and extends along at least 75% of the length of one the side arms.

In one example the beam is a transmit beam.

In one example the beam is a receive beam.

According to a another embodiment there is provided a method of beam management in a wearable device, the wearable device comprising a body portion including a frontend system, one or more sensors, and a beam management circuit; and an external portion connected to the body portion, the external portion including a first antenna array having one or more first antenna elements, the method comprising conditioning, via the frontend system, a plurality of radio-frequency signals using a frontend system, communicating each of the plurality of radio-frequency signals by a corresponding first subset of one or more first antenna elements of a first antenna array to form a beam, the radio-frequency signals having a frequency between 6 GHz and 300 GHz, and controlling, via the beam management circuit, the frontend system to manage the beam based on sensor data generated by one or more sensors.

In one example controlling the frontend system includes controlling the frontend system to adjust an angle of the beam.

In one example controlling the frontend system includes controlling the frontend system to switch transmission from the first antenna array to a second antenna array.

In one example controlling the frontend system includes controlling the frontend system to switch transmission to a second subset of the first antenna elements of the first antenna array.

In one example controlling the frontend system includes controlling the frontend system to adjust the angle of the beam based on sensor data to maintain the beam pointed at an external device.

According to another embodiment there is provided a wearable device comprising a body portion including a frontend system, one or more sensors, a beam management circuit, and a body antenna, an external portion connected to the body portion, the external portion including a first antenna array having one or more first antenna elements, the frontend system being electrically connected to the first antenna array and operable to condition a plurality of radio frequency signals each communicated by a corresponding first subset of the one or more first antenna elements of the first antenna array to thereby form a beam, the radio-frequency signals having a frequency between 6 GHz and 300 GHz, the one or more sensors being configured to generate sensor data; and the beam management circuit for managing the beam, the beam management circuit being configured to control the frontend system to manage the beam based on sensor data generated by the one or more sensors.

In one example the body antenna is configured to communicate radio-frequency signals, the radio-frequency signals having a frequency below 6 GHz.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a schematic diagram illustrating an example of a wearable device.

FIG. 2 is a schematic diagram illustrating an example antenna configuration on a wearable device;

FIG. 3 is a schematic diagram illustrating a wearable device according to aspects of the present invention.

FIG. 4 is a schematic diagram illustrating a wearable device according to further aspects of the present invention.

FIG. 5 is a schematic diagram illustrating a wearable device according to further aspects of the present invention.

FIG. 6 is a schematic diagram illustrating a wearable device according to further aspects of the present invention.

FIG. 7 is a schematic diagram illustrating an antenna configuration on a wearable device according to aspects of the present invention.

FIG. 8 is a schematic diagram illustrating a wearable device according to further aspects of the present invention.

FIG. 9 is a schematic diagram illustrating an antenna configuration on a wearable device according to further aspects of the present invention.

FIG. 10 is a schematic diagram illustrating a wearable device according to further aspects of the present invention.

FIG. 11 is a schematic diagram illustrating a wearable device according to further aspects of the present invention.

FIG. 12 is a schematic diagram of one example of a communication network.

### DETAILED DESCRIPTION

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15, and Phase 2 of 5G technology in Release 16. Subsequent 3GPP releases will further evolve and expand 5G technology. 5G technology is also referred to herein as 5G New Radio (NR).

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

Aspects and embodiments described herein are directed to wearable devices, and in particular the configuration of the antennae used for wireless communications in high frequency bands such as millimeter wave radiofrequency communications. The exemplary embodiments disclosed herein demonstrate ways in which wearable devices having restrictive form factors can be adapted to improve the connectivity thereof. The example used in the application is a smartwatch, wherein the millimeter-wave transmit/receive performance of the smartwatch can be significantly improved by locating the antennae around the wrist strap of the smartwatch. This configuration is particularly advantageous as it allows antenna to maintain 360-degree coverage when the smartwatch is worn by a user. While the primary illustrative example discussed in the application is a smartwatch, it will be appreciated that the invention can be applied to other form factors, as will be described.

Wearable devices are electronic devices that are typically worn as accessories, embedded in clothing, and may be worn close to and/or on the surface of a user's skin. Wearable devices may be hands free devices, or may include some input means such as buttons, and output means such as a screen. Typically, wearable devices include some form of on-board processing, and include means of communicating with other devices nearby such as a user's smartphone. The constant wireless exchange of data between a user's smartphone and their wearable device make wearable devices an ideal candidate for the adoption of next-generation wireless communications technology such as millimeter-wave 5G technology.

As mentioned above, millimeter-wave (mmWave) technology forms part of the development program of 5G NR. In particular, mmWave communications, also known as Frequency Range 2 (FR2), involve communication over high frequencies, such as between 24 GHz and 300 GHz. The high frequency allows communications using mmWave to transfer data even faster than sub-6 GHz communications, and take advantage of a less congested spectrum.

Embodiments of the present invention transmit and/or receive radio-frequency signals in millimeter wave frequency bands in the range of 30 GHz to 300 GHz, or more particularly between 24 GHz and 53 GHz, such as Band n257 (about 26.5 GHz to about 29.5 GHz), Band n258 (about 24.25 GHz to about 27.5 GHz), Band n259 (about 39.5 GHz to 43.5 GHz), Band n260 (about 37 GHz to about 40 GHz), Band n261 (about 27.5 GHz to about 28.35 GHz), and/or Band n262 (about 47.2 GHz to about 48.2 GHz) and/or other equivalent 5G radiofrequency bands in the 5G “Frequency Range 2” range , and/or upper centimeter wave frequencies in the range of 6 GHz to 30 GHz, or more particularly, 24 GHz to 30 GHz.

The increased performance, bandwidth, data-rate, and lower latency of millimeter-wave technology makes it an ideal candidate for incorporation into wearable devices. However, the high-frequency signals themselves present challenges. The transfer distance of mmWave signals tends to be shorter than that of sub-6 GHz (FR1) 5G, and the mmWave signals tend to experience greater attenuation than longer-wavelength communications signals. In addition, mmWave signals can be significantly degraded when the signal is reflected off an object, particularly when data is encoded into differentially-polarized signals. In view of this, performance of mmWave communications is generally improved when the transmit/receive antenna of the device is in direct Line-of-Sight (LoS) of the communications base station. This requirement, in turn, makes the placement of mmWave antennae on wearable devices an important aspect influencing the performance of the wearable device.

Examples of wearable devices include, but are not limited to, smartwatches, fitness trackers, smart glasses, wearable medical alert monitors, safety monitors, body cameras, smart clothing, Bluetooth (RTM) headsets, and physiological sensors.

The fact that wearable devices are worn by a user, rather than simply being carried, means that these devices tend to have more varied and more restrictive form factors. Packaging the various electronic modules and circuitry within a compact device can prove challenging.

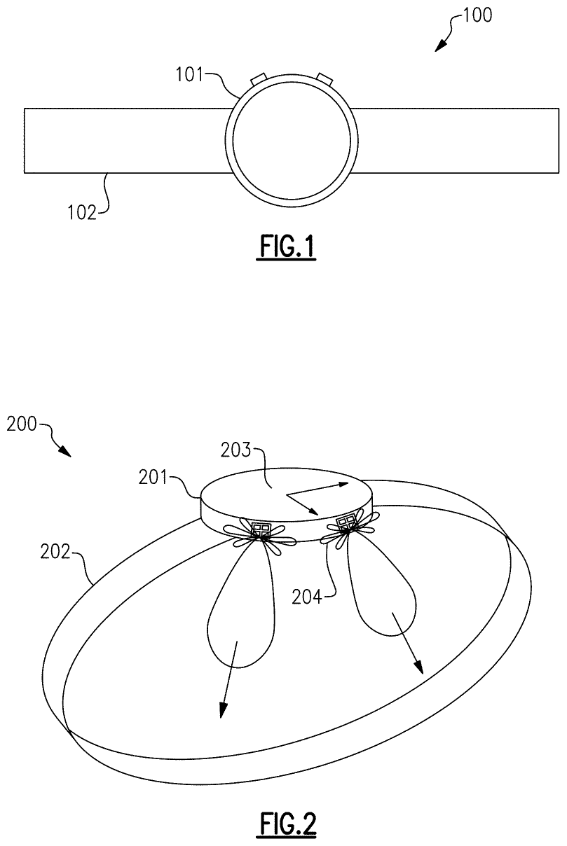

FIG. 1 shows an example of a known wearable device 100. In the example of FIG. 1, the device shown is a smartwatch, having a body portion 101 and a strap 102. Although not shown in FIG. 1, the active electronic elements are embedded within the body portion 101 of the device 100 and may include wireless circuitry 102. The wireless circuitry may include a transceiver module configured to generate and transmit wireless signals via one or more antennas (not shown in FIG. 1), and process wireless signals received via the one or more antennas. Connected between the one or more antennas and the transceiver module may be one or more signal processing modules including one or more band-pass filters, one or more signal amplifiers, and one or more switches. The wearable device 100 may include one or more sensors, such as positioning sensors that are configured to generate sensor data relating to the wearable device. The device 100 includes a screen 103, that is used to present information to a user of the device. It will be appreciated that not all wearable devices include a screen. Some known wearable devices rely on a connected device, such as a user's smartphone, to display information related to the device to the user.

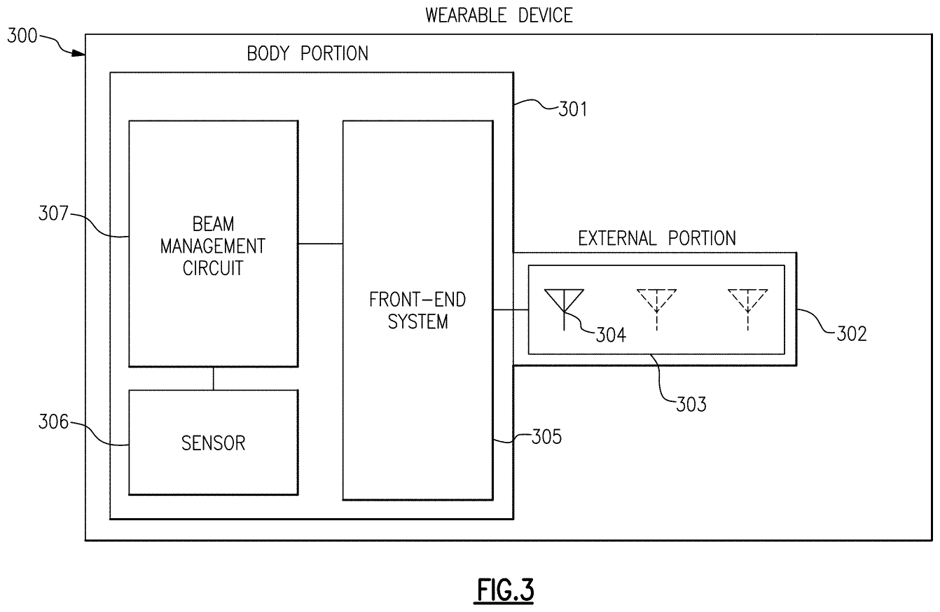

FIG. 2 is a perspective view of the known wearable device 200 that has been configured to incorporate mmWave communications technology. As discussed above in relation to FIG. 1, typically the active electronic elements of device 200 are located within the body portion 201. FIG. 2 shows the mmWave antennas 204 are located on the edge of the body portion 201. Due to the increased attenuation associated with mmWave technology, it may not be possible to house the mmWave antennas underneath the screen 203, within the body portion 201 of the device since the screen itself may significantly attenuate the mmWave signal and result in poor device performance. Accordingly, the mmWave antenna may be located on the edge of the body portion 201 facing outwards from the device 200. However, it will be appreciated that such an arrangement can be disadvantageous. Firstly, locating the antennas 204 on the edge of the device may limit the design of the wearable device 200, since the antennas 204 will place a lower limit on the thickness of the device 200. In addition, the scan angle of the antennas 204 may be limited, due to the limited number, dimensions, and configuration of antennas 204 that can be fitted on the edge of the body portion 201.

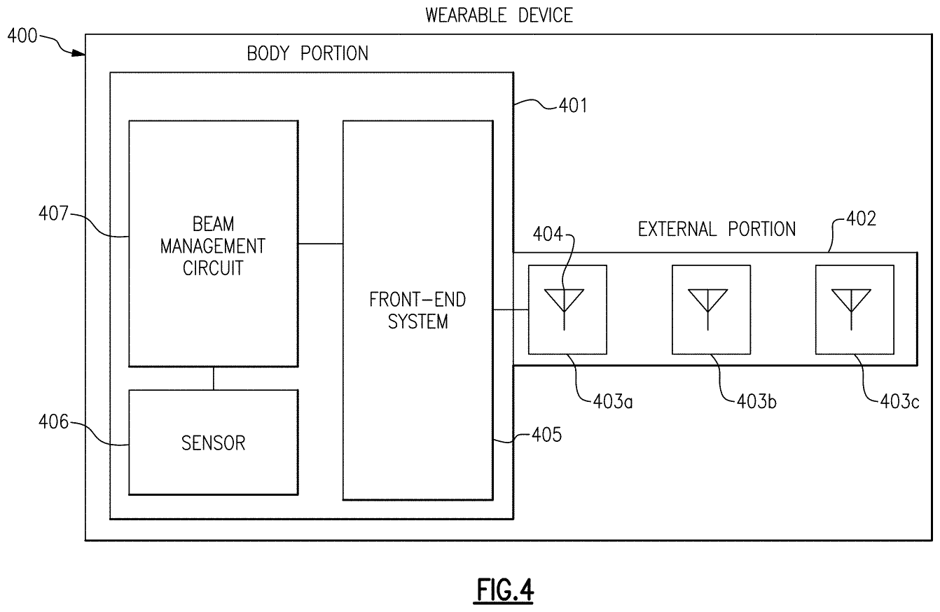

FIG. 3 is a schematic diagram of a wearable device 300 according to an embodiment of the present invention. Wearable device 300 comprises a body portion 301 and an external portion 302.

The wearable device 300 may include active electronic components with the body portion 301. In particular, the wearable device may include a front-end system 305, one or more sensors 306, and a beam management circuit 307. Front-end system 305 is electrically connected to the antenna array. Front-end system may be configured to condition radio-frequency signals transmitted to and/or received from the antenna array 303. Front-end system may include signal conditioning circuitry to provide the signal conditioning functionality. In particular, front-end system 305 may include power amplifiers (PAs), low-noise amplifiers (LNAs), filters, switches, phase shifters, attenuators, duplexers, diplexers, triplexers, circulators, and/or other suitable signal conditioning circuitry for processing RF signals transmitted and/or received from the antenna array 303. For example, front-end system can provide a number of functionalities, including, but not limited to, amplifying signals for transmission, amplifying received signals, filtering signals, filtering signals, switching between different bands, switching between different power modes, switching between transmission and receiving modes, duplexing of signals, multiplexing of signals (for instance, duplexing or triplexing), or some combination thereof. The front-end system 305 may include signal conditioning circuitry including a variable gain amplifier for providing gain control and a variable phase shifter for providing phase control to enable the front-end system 305 to condition radio-frequency signals to perform beam-forming and/or beam steering operations. In particular, for a given antenna array having a first and second antenna element, separated by a separation distance d, by controlling the relative phase of transmit signals provided to the first and second antenna elements, a desired transmit/receive beam angle ⊖ can be achieved. For example, when a first phase shifter associated with the first antenna element has a reference value of 0°, a second phase shifter associated with the second antenna element can be controlled to provide a phase shift of about −2πf(d/v) cos ⊖ radians, where f is the fundamental frequency of the transmit/receive signal, d is the distance between antenna elements, v is the velocity of the radiated wave, and π is the mathematical constant pi.

The signal conditioning circuitry can be used to condition signals for transmission and/or reception via the antenna array 303. With respect to signal transmission, the signal conditioning circuitry can provide transmit signals to the antenna array 303 such that signals radiated from the antenna array 303 combine using constructive and destructive interference to generate an aggregate transmit signal exhibiting beam-like qualities with more signal strength propagating in a given direction away from the antenna array 303.

In the context of signal reception, the signal conditioning circuitry process the received signals (for instance, by separately controlling received signal phases and amplitudes) such that more signal energy is received when the signal is arriving at the antenna array 303 from a particular direction. Accordingly, the wearable device 300 provides directivity for reception of signals.

The relative concentration of signal energy into a transmit beam or a receive beam can be enhanced by increasing the size of the antenna array 303.

The front-end system 305 may be configured to condition radio-frequency signals having a frequency between 10 GHz and 300 GHz. Front-end system 305 may be implemented as a mmWave transmit/receive module. In some embodiments, wearable device 300 may include an additional antenna for communications using alternative communications technologies including, but not limited to, 2G, 3G, 4G (including LTE, LTE-Advanced, and LTE-Advanced Pro), WLAN (for instance, WiFi), WPAN (for instance, Bluetooth (RTM) and ZigBee (RTM)), and/or WMAN (for instance, WiMax) technologies. Front-end system 305 may be further configured to condition wireless signals according to any of the aforementioned communications technologies.

The one or more sensors 306 are configured to generate sensor data. For example, the one or more sensors 306 may comprise a location sensor configured to generate data indicating the location of the wearable device. The one or more sensors may comprise a movement sensor configured to generate data indicating movement of the device. The one or more sensors 306 may comprise various types of sensor including, but not limited to location sensors, movement sensors, light sensors, sound sensors, vibration sensors, proximity sensors, electromagnetic field sensors. The one or more sensors 306 may include a Global Positioning System (GPS) sensor. The GPS sensor may be an L1 & L5 Global Navigation Satellite System (GNSS) module. In some embodiments, the one or more sensors 306 may comprise an accelerometer and/or a gyroscope. In some embodiments, the one or more sensors 306 may comprise an ultra-wideband positioning system, where the sensor data from the ultra-wideband positioning system is used to infer the position and orientation of the wearable device by comparing signal reception times and signal strengths from various signals received by the antenna array 303. The sensor data generated by the one or more sensors 306 may comprise location, position, and/or orientation data. The one or more sensors 306 may output the generated sensor data to the beam management circuit 307.

Beam management circuit 307 may be electrically connected to the one or more sensors 306 and the front-end system 305. The beam management circuit 307 may be configured to control the front-end system 305 to manage transmission and/or receive beams of the antenna array 303. The beam management circuit 307 provides one or more control signals to the front-end system 305 for controlling phase and/or magnitude signal values used by the signal conditioning circuitry of the front-end system 305. Thus, the beam management circuit 307 can manage the transmit or receive beams via the front-end system 305.

The beam management 307 may be configured to manage the transmission and/or receive beams based on one or more signals received by the antenna array 303 and/or sensor data generated by the one or more sensors 306. In certain implementations, the beam management circuit is configured to control beam steering based on one or more signals received via the antenna array 303 and/or sensor data generated by the one or more sensors 306. For example, sensor data generated by the one or more sensors 306 can be used to adjust an angle of the transmit beam so as to maintain the transmit beam pointed at an external device, such as a base station. Additionally or alternatively, sensor data and/or signals received by the antenna array can be used by the beam management circuit 307 for adjusting an angle of a receive beam to maintain a direction of the receive beam aimed toward a base station.

As shown in FIG. 3, wearable device 300 includes an external portion 302 including antenna array 303. The external portion 302 is affixed to the body portion 301 of the wearable device 300 and may be used to secure the wearable device 300 to the body of a user. For example, the external portion may be a strap for securing the wearable device to the user, or a pair of side arms for securing the wearable device on the face of a user. As shown, the external portion 302 may include an array 303 including one or more antenna elements 304. It will be appreciated that providing the antenna array 303 on the external portion 302 of the wearable device 300 can allow an increased flexibility in the design, location, dimensions, and number of antenna array(s) included in the wearable device 300 since the external portion 302 may not be subject to the same restrictions in terms of form factor as the body portion 301 of the device. For example, in the case of a wrist watch, the body portion 301 may be small in size and include a large number of components, thus leaving little remaining room for an antenna. On the other hand, the external portion 302 may be a strap arranged to wrap around a body part of a user, such as a user's wrist. In this regard, the external portion 302 may naturally provide a platform for one or more antenna array(s) having 360-degree coverage in order to significantly improve the visibility of the antenna array(s) to an external device such as a base station. Furthermore, the external portion of a wearable device, such as a strap, typically will not include any components thus leaving the whole of the external portion 302 free to accommodate varied configurations of antenna arrays. This is particularly advantageous when the antenna array 303 is intended to receive radio-frequency signals having a frequency between 6 GHz and 300 GHz, such as millimeter-wave, or centimeter-wave radio-frequency signals.

In some embodiments, the body portion 301 can further include at least one body antenna. For example, the body antenna may be arranged on an edge of the body portion 301 like the antennas 204 on the body portion 201 of the device 200 of FIG. 2. The body antenna(s) can be configured for operation at different frequency ranges, depending on the embodiment. For instance, in some embodiments, the body antenna(s) is configured for operation at frequencies below 6 GHz, while the antennas 304 of the external portion 302 are configured for operation at frequencies at or above 6 GHz. In other embodiments, the body antenna(s) and the antennas 304 of the external portion 302 are configured for operation at or above 6 GHz (e.g., between 6 GHz and 300 GHz).

FIG. 4 is a schematic diagram of a wearable device 400 according to an embodiment of the present invention. Wearable device 400 includes a body portion 401, and an external portion 402.

The body portion 401 of wearable device 400 includes active electronic components corresponding to those of wearable device 300 described above in connection to FIG. 3. In particular, body portion 401 includes a front-end system 405, one or more sensors 406, and a beam management circuit 407.

The front-end system 405, one or more sensors 406, and beam management circuit 407 of wearable device 400 may be configured to operate correspondingly to front-end system 305, one or more sensors 306, and beam management circuit 307 described above.

As shown in FIG. 4, wearable device 400 includes an external portion 402 including a plurality of antenna arrays 403a-c. Although three antenna arrays 403a, 403b, and 403c are illustrated in FIG. 4, it will be appreciated that the external portion 402 of wearable device 400 may include two antenna arrays, or four or more antenna arrays. Antenna arrays 403a-c may each comprise one or more antenna elements.

In embodiments of wearable device 400 including an external portion 402 having a plurality of antenna arrays 403a-c, the beam management circuit 407 may be configured to control the front-end system 405 to switch transmission or reception from a first antenna array of the plurality of antenna arrays 403a-c to a second antenna array of the plurality of antenna arrays 403a-c. In particular, when wearable device 400 is transmitting or receiving data to/from an external device via a first antenna array, beam management circuit 407 may be configured to switch transmission from the first antenna array to a second antenna array based on one or more signals received via one or more of the antenna arrays and/or sensor data generated by the one or more sensors 406.

For example, beam management circuit 407 may receive one or more signals from a first antenna array of the plurality of antenna arrays 403a-c. The beam management circuit 407 may measure the signal intensity of the received one or more signals, or receive a measure of the signal intensity from the front-end system 405. The beam management circuit 407 may compare the measured signal intensity to a predetermined threshold. If the measured signal intensity value is below the predetermined threshold value, the beam management circuit 407 may switch transmission or reception from the first antenna array to a second antenna array. In embodiments of the wearable device 400 comprising three or more antenna arrays, the beam management circuit 407 may determine which antenna array of the remaining antenna arrays transmission or reception should be switched to by comparing signals received by each of the remaining antenna arrays. In particular, beam management circuit 407 may receive one or more signals from each of the remaining antennas. Beam management circuit 407 may measure the signal intensity of the received one or more signals from each remaining antenna, and compare the measured signal intensities from the remaining antennas with each other, and with the measured signal intensity from the first antenna. The beam management circuit 407 may then switch transmission or reception to the antenna with the highest measured signal intensity. In other embodiments, the beam management circuit 407 may determine to switch transmission or reception from a first antenna to a second antenna based on a comparison of reception times of a signal received by a subset of the plurality of antenna arrays 403a-c. For example, an external device such as a base station may transmit a signal at time t₀, which is received by antenna array 403a at time tₐ, antenna array 403b at time t_{b}, and antenna array 403c at time t_{c}. The beam management circuit 407 may calculate, based on the reception times t_{a-c}, the orientation of the wearable device 400 relative to the external device. In this regard, the beam management circuit 407 may use the known positions and orientations of each of the plurality of antennas 403a-c relative to each other. Based on the calculated orientation of the wearable device 400, beam management circuit 407 may determine that one of the other antenna arrays is in a more suitable orientation relative to the external device. For example, beam management circuit 407 may determine that the external device is at the edge of the field-of-view (FoV) of the first antenna array, but closer to the center of the FoV of a second antenna, and may therefore determine to switch transmission or reception from the first antenna array to the second antenna array.

Alternatively or additionally, beam management circuit 407 may receive sensor data generated by the one or more sensors 406. For example, beam management circuit 407 may receive position data generated by the one or more sensors. The position data received from the one or more sensors may comprise an orientation of the wearable device 400. The beam management circuit 407 may determine, based on the received position data, that one or the other antenna arrays is in a more suitable orientation relative to the external device. In other examples, the position data received from the one or more sensors 406 may comprise accelerometer data. The beam management circuit 407 may determine, based on the accelerometer data, an angle and axis of rotation of the wearable device 400. For example, the beam management circuit 407 may receive accelerometer data from the one or more sensors and determine that the wearable device 400 has been rotated through an angle of 90 degrees with a rotation axis perpendicular to the external portion 402. In response to the determination, the beam management circuit 407 may decide to switch transmission to a second antenna array. In this regard, beam management circuit 407 may use the known positions and orientations of each of the plurality of antennas 403a-c relative to each other. In particular, the beam management circuit 407 may use the determined angle and axis of rotation, and known relative antenna array positions, to calculate whether one of the remaining antenna arrays is in a more suitable orientation relative to the external device, and may control the front-end system 405 to switch transmission or reception to this antenna array.

In certain embodiments wearable device 400 may be used to augment connectivity of user's additional wireless device. The user of wearable device 400 may have in their possession an additional wireless communications device, such as a smartphone, tablet, laptop computer etc. The additional wireless communications device may or may not be configured to communicate using millimeter-wave 5G communications technology. The wearable device 400 may be configured to connect to the user's additional device using other wireless communications technology such as Bluetooth(RTM), sidelink, WiFi, LTE/NR, or other suitable means. By providing a wireless data connection between the wearable device 400 and the user's additional device, the wearable device is able to supplement the connectivity of the user's additional device by receiving data via the one or more antenna arrays, and transmit the received data to the user's additional wireless device. For example, the user's device may not be able to communicate using millimeter-wave 5G communications, in which case the wearable device 400 can provide millimeter-wave wireless communications capability to the user's device by transmitting/receiving over millimeter-wave 5G technology, then communicating the data with the user's device. Alternatively, the user's device may be millimeter-wave 5G enabled, but the millimeter-wave 5G antenna of the user's device may be blocked by an environmental obstacle such as the user's clothing, or the user's hand. In such a case, the millimeter-wave 5G antenna of the wearable device 400 may still have line-of-sight of the communications base station, and can transmit/receive data to/from the base station and then communicate the data to the user's device over another wireless connection. It should be appreciated that the methods described herein need not be limited to millimeter-wave 5G communications, and are equally applicable to other wireless communications technologies.

The methods implemented by wearable device 400 described above can be particularly beneficial in a wearable device having a plurality of antenna arrays located on an external portion 402, in accordance with embodiments of the present invention. The external portion 402 of the wearable device 400 is located on the outside of the device, and therefore antennas mounted on the external portion 402 are likely to have improved visibility and line-of-sight to any external device. In certain embodiments, the external portion 402 may be a strap for securing the wearable device 400 to a user. In such cases, providing a plurality of antennas mounted on the external portion, and utilizing the methods described herein to switch between antennas as required, can help ensure 360-degree antenna coverage and improve connection performance of the wearable device 400.

In some embodiments, the body portion 401 can further include at least one body antenna. For example, the body antenna may be arranged on an edge of the body portion 401 like the antennas 204 on the body portion 201 of the device 200 of FIG. 2. The body antenna(s) can be configured for operation at different frequency ranges, depending on the embodiment. For instance, in some embodiments, the body antenna(s) is configured for operation at frequencies below 6 GHz, while the antennas 404 of the external portion 402 are configured for operation at frequencies at or above 6 GHz. In other embodiments, the body antenna(s) and the antennas 404 of the external portion 402 are configured for operation at or above 6 GHz (e.g., between 6 GHz and 300 GHz).

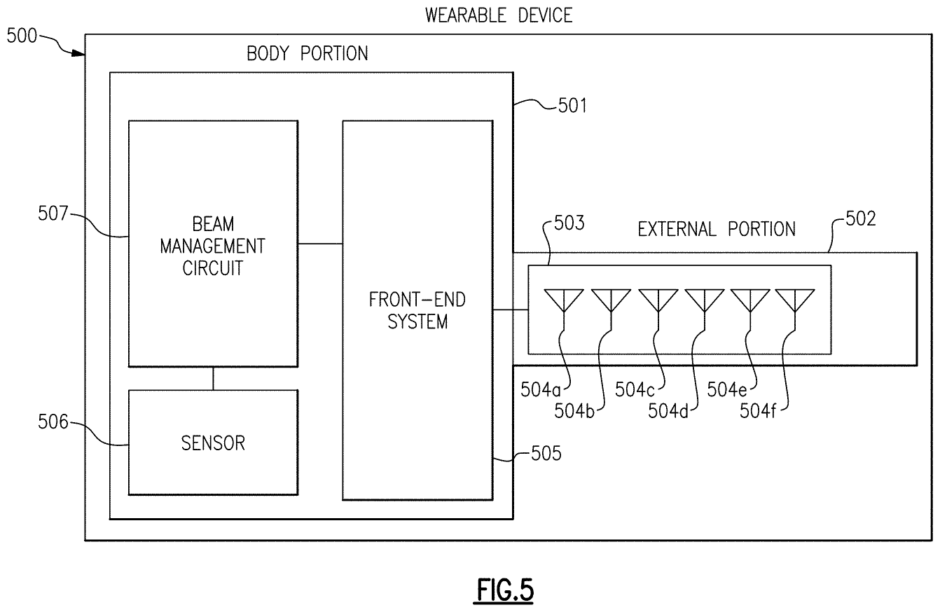

FIG. 5 is a schematic diagram of a wearable device 500 according to an embodiment of the present invention. Wearable device 500 includes a body portion 501, and an external portion 502.

The body portion 501 of wearable device 500 includes active electronic components corresponding to those of wearable device 300 described above in connection to FIG. 3. In particular, body portion 501 includes a front-end system 505, one or more sensors 506, and a beam management circuit 507.

The front-end system 505, one or more sensors 506, and beam management circuit 507 of wearable device 500 may be configured to operate correspondingly to front-end system 305, one or more sensors 306, and beam management circuit 307 described above. In addition, though wearable device 500 is described as having one antenna array 503, it will be appreciated that wearable device 500 may include multiple antenna arrays, and implement any of the methods described above in relation to wearable device 400 shown in FIG. 4.

As shown in FIG. 5, wearable device 500 includes an external portion 502 including an antenna array 503. Antenna array 503 includes a plurality of antenna elements 504a-f. Although six antenna elements 504a-f are shown in FIG. 5, it will be appreciated that the antenna array 503 of wearable device 500 may include any number of antenna elements. In FIG. 5, the antenna array 503 is shown extending along approximately 75% of the length of the external portion 502, however, in some embodiments, antenna array 503 may extend along between 30% and 100% of the length of the external portion, or along at least 50% the length of external portion 502. In certain embodiments, antenna array 503 may extend along less than 30% the length of external portion. In such embodiments, wearable device 500 may include a plurality of antenna arrays, each with a plurality of antenna elements, and arranged to extend, in combination, along between 30% and 100%, or along at least 50%, or at least 75%, the length of external portion 502.

In embodiments of wearable device 500 including an external portion having an antenna array including a plurality of antenna elements, the beam management circuit 507 may be configured to control the front-end system 505 to switch transmission or reception from a first subset of antenna elements to a second subset of antenna elements. In particular, when wearable device 500 is transmitting or receiving data to/from an external device via a first subset of antenna elements 504a-f, beam management circuit 507 may be configured to switch transmission from the first subset to a second subset based on one or more signals received via one or more of the antenna elements and/or sensor data generated by the one or more sensors 506.

For example, beam management circuit 507 may receive one or more signals from a second subset of antenna elements 504a-f. The beam management circuit 507 may measure the signal intensity of the received one or more signals, or receive a measure of the signal intensity from the front-end system 505. The beam management circuit 507 may compare the measured signal intensity to a predetermined threshold. If the measured signal intensity value is below the predetermined threshold value, the beam management circuit 507 may switch transmission or reception from the first subset of antenna elements 504a-f to a second subset of antenna elements 504a-f. Beam management circuit 507 may control front-end system 505 to iteratively scan through subsets of antenna elements 504a-f to determine which subset of antenna elements should be switched to. For example, when wearable device is transmitting or receiving to/from an external device via the first four adjacent antenna elements 504a to 504d of antenna array 503, the beam management circuit 507 may control front-end system 505 to measure a signal intensity received when activating antenna elements 504b to 504e, then elements 504c to 504f and so on. The beam management circuit 507 may then compare the measured signal intensities from each subset of antenna elements 504a-f, and switch transmission or reception to the subset of antenna elements 504a-f with the highest measured signal intensity.

Alternatively or additionally, beam management circuit 507 may receive sensor data generated by the one or more sensors 506. The beam management circuit 507 may implement methods corresponding to those set out above in relation to wearable device 400, in order to switch transmission or reception from a first subset of antenna elements 504a-f to a second subset of antenna elements 504a-f based on the received sensor data generated by the one or more sensors 506.

Embodiments of wearable device 500 including one or more antenna arrays 503 having a plurality of antenna elements 504a-f may also implement methods to improve the performance of signal transmission and reception. As is known, the relative concentration of signal energy into a transmit beam or a receive beam can be enhanced by increasing the size of the antenna array. When wearable device 500 is transmitting or receiving signals to/from an external device via a first subset of antenna elements 504a-f, the beam management circuit 507 may be configured to activate and transmit or receive using additional antenna elements adjacent to the antenna elements of the first subset in order to increase the size of the transmit/receive array, and thereby boost transmission/reception performance. For example, if wearable device 500 is transmitting a signal to a base station using antenna elements 504b, 504c, 504d, and 504e, the beam management circuit 507 may control front-end system 505 to activate antenna elements 504a and 504f. Wearable device 500 may then transmit the signal using antenna elements 504a-f, thereby achieving a stronger transmit beam.

Although in FIG. 5, the antenna array 503 is shown as including a 1×6 array of antenna elements 504a-f, other configurations of antenna elements may be used. Antenna array 503 may include a 2×n array of antenna elements, or a 3×n array of antenna elements, or an m×n array of antenna elements. By including multiple rows of elements extending width-wise across external portion 502, the beam management circuit 507 may control the front-end system 505 to implement the beam-forming and/or beam steering operations described above in two dimensions, thereby further improving transmit/receive performance and connection stability.

In some embodiments, the body portion 501 can further include at least one body antenna. For example, the body antenna may be arranged on an edge of the body portion 501 like the antennas 204 on the body portion 201 of the device 200 of FIG. 2. The body antenna(s) can be configured for operation at different frequency ranges, depending on the embodiment. For instance, in some embodiments, the body antenna(s) is configured for operation at frequencies below 6 GHz, while the antennas 504 of the external portion 502 are configured for operation at frequencies at or above 6 GHz. In other embodiments, the body antenna(s) and the antennas 504 of the external portion 502 are configured for operation at or above 6 GHz (e.g., between 6 GHz and 300 GHz).

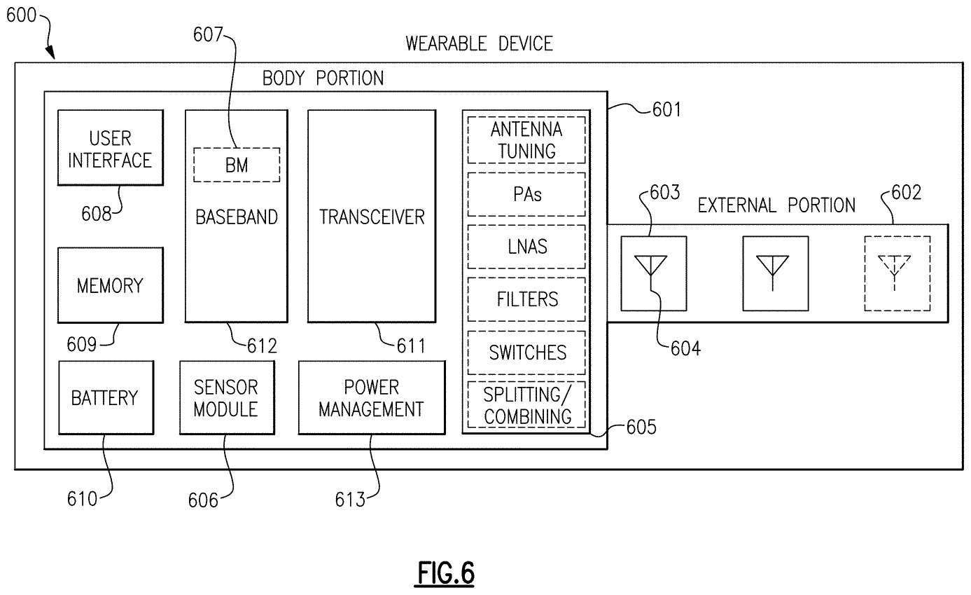

FIG. 6 is a schematic diagram illustrating a specific embodiment of a wearable device 600. Wearable device 600 includes a body portion 601 and an external portion 602.

The body portion 601 of wearable device 600 includes a baseband system 612, a transceiver 611 (implemented as a millimeter-wave transmit/receive module, in this example), sensor module 606, front-end module 605, a power management system 610, and a battery 610.

The external portion 602 of wearable device 600 includes one or more antenna arrays 603, each comprising one or more antenna elements 604.

The transceiver 611 generates RF signals for transmission and processes incoming RF signals received from the one or more antenna arrays 603. It will be understood that various functionalities associated with the transmission and receiving of RF signals can be achieved by one or more components that are collectively presented in FIG. 6 as the transceiver 611. In certain examples, separate components (for instance, separate circuits or dies) can be provided for handling certain types of RF signals. For example, in certain embodiments, wearable device 600 may include additional components for handling RF signals associated with other communications technologies, including, but not limited to, 2G, 3G, 4G (including LTE, LTE-Advanced, and LTE-Advanced Pro), WLAN (for instance, WiFi), WPAN (for instance, Bluetooth and ZigBee), and/or WMAN (for instance, WiMax).

The front-end system 605 aids in conditioning signals transmitted and/or received from the one or more antenna arrays 603.

In the illustrated embodiment, the front-end system 605 includes antenna tuning circuitry, power amplifiers (PAs), low noise amplifiers (LNAs), filters, switches, and signal splitting/combining circuitry. However, other implementations are possible.

For example, the front-end system 605 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the wearable device 600 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The one or more antenna arrays 603 can include antennas used for a wide variety of types of communications. For example, the one or more antenna arrays 603 can include antennas for transmitting and/or receiving signals associated with a wide variety of frequencies and communications standards.

In certain implementations, the one or more antenna arrays 603 sup-port MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The wearable device 600 can implement beam-forming and beam-steering in accordance with the methods described herein. Beam management circuit 607 is integrated into the baseband system 612, and configured to perform the beam-forming, beam-steering, antenna-switching, and antenna-subset-switching methods described above in relation to FIGS. 3-5.

The baseband system 612 is coupled to the user interface 608 to facilitate processing of various user input and output (I/O), such as voice and data. The baseband system 612 provides the transceiver 611 with digital representations of transmit signals, which the transceiver 611 processes to generate RF signals for transmission. The baseband system 612 also processes digital representations of received signals provided by the transceiver 611. As shown in FIG. 6, the baseband system 612 is coupled to the memory 609 of facilitate operation of the mobile device 800.

The memory 609 can be used for a wide variety of purposes, such as storing data and/or instructions to facilitate the operation of the mobile device 600 and/or to provide storage of user information.

The power management system 613 provides a number of power management functions of the mobile device 600. In certain implementations, the power management system 613 includes a PA supply control circuit that controls the supply voltages of the power amplifiers. For example, the power management system 613 can be configured to change the supply voltage(s) provided to one or more of the power amplifiers to improve efficiency, such as power added efficiency (PAE).

As shown in FIG. 6, the power management system 613 receives a battery voltage from the battery 610. The battery 610 can be any suitable battery for use in the mobile device 600, including, for example, a lithium-ion battery.

In some embodiments, the body portion 601 can further include at least one body antenna. For example, the body antenna may be arranged on an edge of the body portion 601 like the antennas 204 on the body portion 201 of the device 200 of FIG. 2. The body antenna(s) can be configured for operation at different frequency ranges, depending on the embodiment. For instance, in some embodiments, the body antenna(s) is configured for operation at frequencies below 6 GHz, while the antennas 604 of the external portion 602 are configured for operation at frequencies at or above 6 GHz. In other embodiments, the body antenna(s) and the antennas 604 of the external portion 602 are configured for operation at or above 6 GHz (e.g., between 6 GHz and 300 GHz).

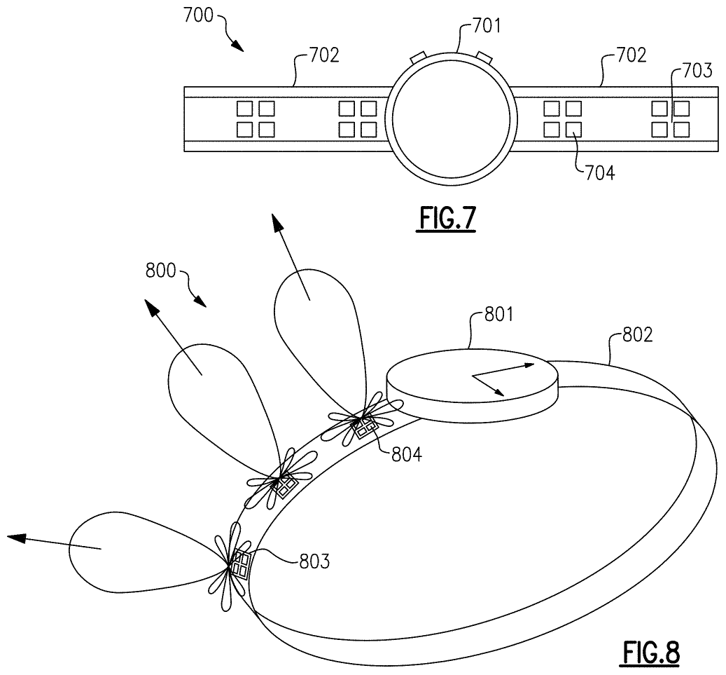

FIG. 7 is an illustration showing a specific embodiment of a wearable device 700 in accordance with the present invention. The wearable device 700 is a wristwatch having a body portion 701, and external portion 702.

The body portion 701 of the wearable device 700 includes active electronic components, including those described in relation to FIGS. 3 to 6 above. In particular, body portion 701 includes a front-end system, one or more sensors, and a beam management circuit.

The active electronic components of wearable device 700 may be configured to operate correspondingly to the wearable devices described above in relation to FIGS. 3 to 6.

As shown, the wearable device 700 also includes a display, for displaying information to the user, and buttons for receiving input from the user. In other embodiments, the display of the wearable device 700 may be a touch-screen, allowing user input as well as output. The presence of the display may prevent a millimeter-wave antenna from being mounted within the body portion 701 of the wearable device 700, especially an antenna arranged to transmit/receive through the display of the wearable device 700. This is due to the increased attenuation experienced by millimeter-wave RF signals.

As shown in FIG. 7, wearable device 700 includes an external portion 702 including a plurality of antenna arrays 703. Each of the antenna arrays include a plurality of antenna elements 704. The external portion 702 of wearable device 700 is a strap for securing the wearable device 700 to the wrist of a user. The strap may be formed in two sections, as shown, each connected to the body portion 701 of the wearable device 700, and including a fastening means for joining the two parts together around the wrist of a user. Alternatively, the strap may be formed as a single piece, having a fastening means to secure the wearable device 700 to the wrist of the user.

As will be appreciated, when the wearable device 700 is secured to the wrist of the user, the strap on which the plurality of antennas are mounted forms a loop around the user's wrist, as also shown in FIG. 8. Accordingly, the one or more antenna arrays 703 may provide substantially 360-degree communications field-of-view to the wearable device 700. In addition, since all the antenna arrays are arranged to face outwards from the user's wrist, challenges associated with tissue absorption of millimeter-wave RF signals are minimized.

FIG. 8 shows a wearable device 800 in accordance with the present invention. The wearable device 800 corresponds to the wearable device 700 shown in FIG. 7, but shown in a configuration as the wearable device 800 would be worn by a user. In addition, the wearable device 800 has more antenna arrays 803 that are arranged so as to provide substantially 360-degree field-of-view around the wearable device 800.

As can be seen, each of the plurality of antenna arrays 803 has a different field-of-view, and each antenna array 803 has a plurality of antenna elements 804 allowing the beam management circuit to perform beam-forming and beam-steering operations on each of the antenna arrays. In addition, the presence of multiple antenna arrays 803 allows the beam management circuit to implement the methods described above in relation to FIG. 4, to switch transmission or reception from a first antenna array to a second antenna array based on one or more signals received by one or more of the antenna arrays 803 and/or sensor data generated by the one or more sensors of the wearable device 800.

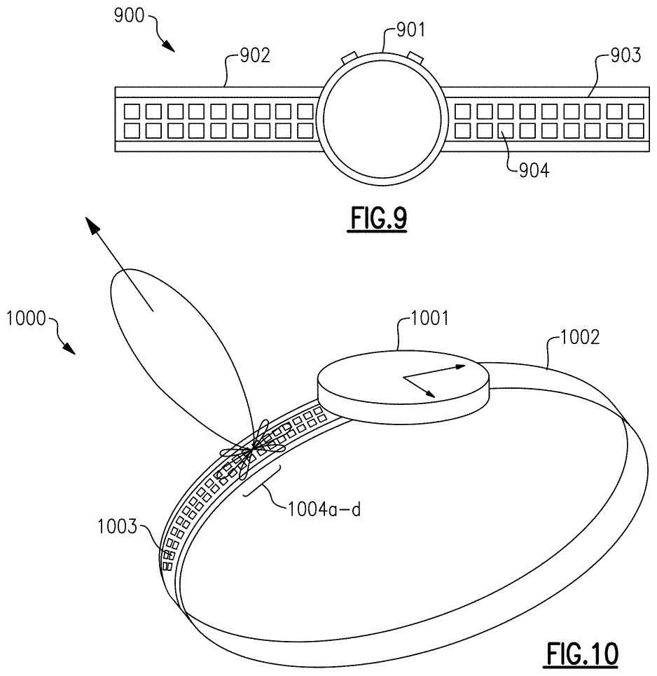

FIG. 9 is an illustration showing a specific embodiment of a wearable device 900 in accordance with the present invention. The wearable device 900 is a wristwatch having a body portion 901, and external portion 902.

The body portion 901 of the wearable device 900 includes active electronic components, including those described in relation to FIGS. 3 to 6 above. In particular, body portion 901 includes a front-end system, one or more sensors, and a beam management circuit.

The active electronic components of wearable device 900 may be configured to operate correspondingly to the wearable devices described above in relation to FIGS. 3 to 6.

As shown, the wearable device 900 also includes a display, for displaying information to the user, and buttons for receiving input from the user. In other embodiments, the display of the wearable device 900 may be a touch-screen, allowing user input as well as output. The presence of the display may prevent a millimeter-wave antenna from being mounted within the body portion 901 of the wearable device 900, especially an antenna arranged to transmit/receive through the display of the wearable device 900. This is due to the increased attenuation experienced by millimeter-wave RF signals.

As shown in FIG. 9, wearable device 900 includes an external portion 902 including an antenna array 903. Antenna array 903 includes a plurality of antenna elements 904 and extends along the length of the external portion 902. The external portion 902 of wearable device 900 is a strap for securing the wearable device 900 to the wrist of a user.

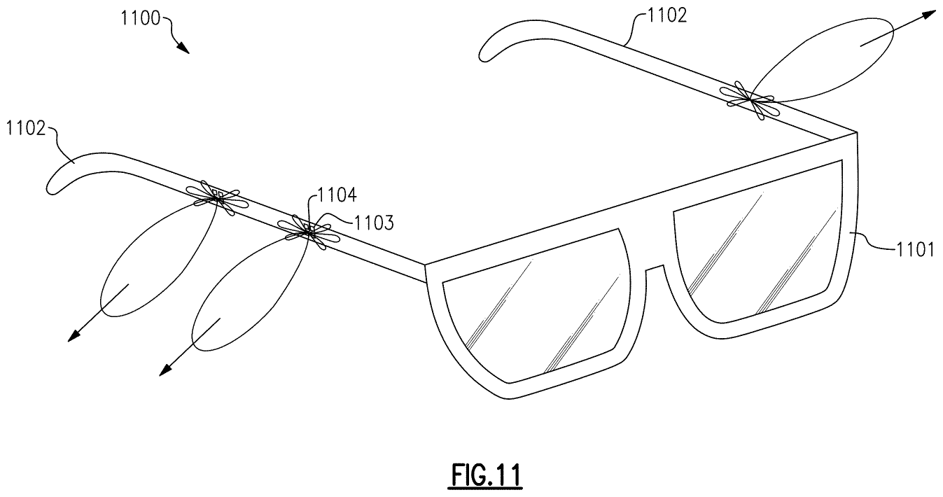

FIG. 10 shows a wearable device 1000 in accordance with the present invention. The wearable device 900 corresponds to the wearable device 900 shown in FIG. 9, but shown in a configuration as the wearable device 1000 would be worn by a user. As can be see, antenna array 1003 including plurality of antenna elements 1004 are arranged so as to provide 360-degree field-of-view around the wearable device 1000.

The plurality of antenna elements 1004 allows the beam management circuit to perform beam-forming and beam-steering operations on the antenna array 1003. In addition, the configuration of the antenna elements 1004 allows the beam management circuit to implement the beam scanning, and antenna-element-switching operations described above in relation to FIG. 5.

FIG. 11 is an illustration showing a specific embodiment of a wearable device 1100 in accordance with the present invention. The wearable device 1100 is a pair of smart glasses having a body portion 1101, and external portion 1102.

In the embodiment shown, the body portion 1101 of wearable device 1100 may be the face portion of the smart glasses frame, configured to hold the lenses of the smart glasses in position. The body portion 1101 includes active electronic components, including those described in relation to FIGS. 3 to 6 above. In particular, body portion 1101 includes a front-end system, one or more sensors, and a beam management circuit.

The active electronic components of wearable device 1100 may be configured to operate correspondingly to those of the wearable devices described above in relation to FIGS. 3 to 6.

As shown, the body portion 1100 of wearable device 1100 presents a particularly restrictive form factor, having little room to fit the active electronic components of the wearable device 1100.

As shown in FIG. 11, wearable device 1100 includes an external portion 1102 including a plurality of antenna arrays 1103, each comprising a plurality of antenna elements 1104. The external portion 1102 of the wearable device is a pair of side-arms for holding the pair of smart glasses on the head of the user.

As will be appreciated, when the wearable device 1100 is being worn by a user, the pair of side arms on which the plurality of antenna arrays 1103 are mounted provide a substantial communications field-of-view to the wearable device 1100. The field-of-view of the antenna arrays 1103 can be further improved by adjusting the dimensions, and number of antenna elements 1104 of the plurality of antenna arrays 1103. Since all the antenna arrays 1103 are arranged to face outwards from the user's head, challenges associated with tissue absorption of millimeter-wave RF signals are minimized.

With reference to FIGS. 7-11, in some embodiments, the body portion 701, 801, 901, 1001, 1101 of each of the devices 700, 800, 900, 1000, 1100, respectively, can further include at least one body antenna. For example, the body antenna may be arranged on an edge of the body portion 601 like the antennas 204 on the body portion 201 of the device 200 of FIG. 2. The body antenna(s) can be configured for operation at different frequency ranges, depending on the embodiment. For instance, in some embodiments, the body antenna(s) is configured for operation at frequencies below 6 GHz, while the antennas 704, 804, 904, 1004, 1104 of the respective external portions 702, 802, 902, 1002, 1102 are configured for operation at frequencies at or above 6 GHz. In other embodiments, the body antenna(s) and the antennas 704, 804, 904, 1004, 1104 of the respective external portions 702, 802, 902, 1002, 1102 are configured for operation at or above 6 GHz (e.g., between 6 GHz and 300 GHz).

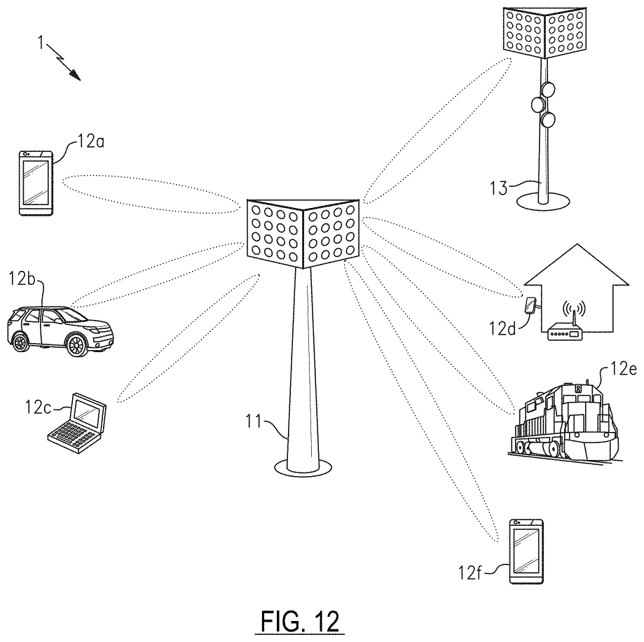

FIG. 12 is a schematic diagram of one example of a communication network 1. The communication network 1 includes a macro cell base station 11, a small cell base station 13, and various examples of user equipment (UE), including a first mobile device 12a, a wireless-connected car 12b, a laptop 12c, a stationary wireless device 12d, a wireless-connected train 12e, and a second mobile device 12f.

Although specific examples of base stations and user equipment are illustrated in FIG. 12, a communication network can include base stations and user equipment of a wide variety of types and/or numbers.

For instance, in the example shown, the communication network 1 includes the macro cell base station 11 and the small cell base station 13. The small cell base station 13 can operate with relatively lower power, shorter range, and/or with fewer concurrent users relative to the macro cell base station 11. The small cell base station 13 can also be referred to as a femtocell, a picocell, or a microcell. Although the communication network 1 is illustrated as including two base stations, the communication network 1 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. For example, the user equipment can include any of the wearable devices described herein, including any of the wearable devices of FIGS. 1-11.

The illustrated communication network 1 of FIG. 12 supports communications using a variety of technologies, including, for example, 4G LTE, 5G NR, and wireless local area network (WLAN), such as Wi-Fi. Although various examples of communication technologies have been provided, the communication network 1 can be adapted to support a wide variety of communication technologies.

Various communication links of the communication network 1 have been depicted in FIG. 12. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communication with a base station using one or more of 4G LTE, 5G NR, and Wi-Fi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed Wi-Fi frequencies).

The communication links can operate over a wide variety of frequencies. In certain implementations, communications are supported using 5G NR technology over one or more frequency bands that are less than 6 Gigahertz (GHz) and/or over one or more frequency bands that are greater than 6 GHz. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz.

Different users of the communication network 1 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDM is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 1 of FIG. 12 can be used to support a wide variety of advanced communication features, including, but not limited to, eMBB, uRLLC, and/or mMTC.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

While specific embodiments of, and examples for, the invention are described above for illustrative purposes, various equivalent modifications are possible within the scope of the invention, as those ordinary skilled in the relevant art will recognize in view of the disclosure herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The teachings of the invention provided herein can be applied to other systems, not necessarily the systems described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions, and changes in the form of the methods and systems described herein may be made without departing from the spirit of the disclosure. The accompanying claims and their equivalents are intended to cover such forms or modifications as would fall within the scope and spirit of the disclosure.

1. A wearable device, comprising:
a body portion including a frontend system, one or more sensors, and a beam management circuit;
an external portion connected to the body portion, the external portion including a first antenna array having one or more first antenna elements, the frontend system being electrically connected to the first antenna array and operable to condition a plurality of radio frequency signals each communicated by a corresponding first subset of the one or more first antenna elements of the first antenna array to thereby form a beam, the radio-frequency signals having a frequency between 6 GHz and 300 GHz, the one or more sensors being configured to generate sensor data, the beam management circuit configured to control the frontend system to manage the beam based on one or more signals received via the first antenna array.

2. The wearable device of claim 1 wherein the external portion is a strap for securing the wearable device to a user.

3. The wearable device of claim 1 wherein the external portion includes a plurality of antennas arranged along the length of the external portion.

4. The wearable device of claim 1 wherein the first antenna includes a plurality of first antenna elements and extends along at least 75% the length of the external portion.

5. The wearable device of claim 1 wherein the beam management is circuit is configured to adjust an angle of the beam.

6. The wearable device of claim 1 wherein the external portion further includes a second antenna array including one or more second antenna elements.

7. The wearable device of claim 6 wherein the beam management circuit is configured to control the frontend system to switch transmission from the first antenna array to the second antenna array.

8. The wearable device of claim 1 wherein the first antenna array includes a plurality of first antenna elements, and the beam management circuit is configured to control the frontend system to switch transmission to a second subset of the one or more first antenna elements of the first antenna array.

9. The wearable device of claim 1 wherein the beam management circuit is configured to control the frontend system to adjust the angle of the beam based on the one or more received signals to maintain the beam pointed at an external device.

10. The wearable device of claim 1 wherein the one or more sensors include a Global Positioning System (GPS) sensor.

11. The wearable device of claim 1 wherein the one or more sensors include an accelerometer.

12. The wearable device of claim 2 wherein the wearable device is a wristwatch.

13. The wearable device of claim 1 wherein the wearable device is a pair of smart glasses, the external portion including a pair of side arms.

14. The wearable device of claim 13 wherein the wearable device includes a plurality of antennas arranged along the length of one or each of the side arms.

15. The wearable device of claim 13 wherein the first antenna includes a plurality of first antenna elements and extends along at least 75% of the length of one the side arms.

16. A wearable device, comprising:
a body portion including a frontend system, one or more sensors, a beam management circuit, and a body antenna; and
an external portion connected to the body portion, the external portion including a first antenna array having one or more first antenna elements, the frontend system electrically connected to the first antenna array and operable to condition a plurality of radio frequency signals each communicated by a corresponding first subset of the one or more first antenna elements of the first antenna array to thereby form a beam, the radio-frequency signals having a frequency between 6 GHz and 300 GHz, the one or more sensors being configured to generate sensor data, and the beam management circuit configured to control the frontend system to manage the beam based on one or more signals received by the first antenna array.

17. The wearable device of claim 16 wherein the body antenna is configured to communicate radio-frequency signals, the radio-frequency signals having a frequency below 6 GHz.

18. The wearable device of claim 16 wherein the external portion is a strap for securing the wearable device to a user.

19. The wearable device of claim 16 wherein the external portion includes a plurality of antennas arranged along the length of the external portion.

20. The wearable device of claim 16 wherein the first antenna includes a plurality of first antenna elements and extends along at least 75% the length of the external portion.
